(19) United States
(12) Patent Application Publication
(10) Pub. No.: US 2011/0131002 A1
(43) Pub. Date: Jun. 2, 2011

(54) METHOD FOR AUTOMATIC TESTING OF SOFTWARE

(76) Inventor: Simeon Falk Sheye, Herlev (DK)

(21) Appl. No.: 12/992,853

(22) PCT Filed: May 15, 2008
(86) PCT No.: PCT/EP2008/055947

§ 371 Date: Feb. 3, 2011

(51) Int. Cl. G06F 19/00

(52) U.S. Cl. 702/123

(57) ABSTRACT

The invention relates to a method of automatic testing of a first software system using a test specification, the first software system comprising data and interacting with a third software system communicatively coupled to a database; the method comprising defining at least one operation; wherein an operation operates on at least one of at least one entity; defining at least one test condition; wherein a test condition defines at least one required value of a number of properties of at least one entity in order for the at least one entity to be passed on to the at least one operation and wherein said at least one test condition is defined by at least one condition generating expression in said test specification; operating, via said third software system, said at least one operation on said first software system, transmitting from the first software system to the third software system first data representing a result of said at least one operation operating on said first software system; if the first data satisfies at least one criterion used by at least one test condition then storing said first data in said database.

### FIELD OF THE INVENTION

This invention relates to a method of automatic testing of a first software system in a first data processing system, the first software system comprising first data and interacting with a second software system comprising at least one entity comprising at least one property and at least one operation, the second software system interfacing with a third software system communicatively coupled to a database in a storage device. The invention further relates to a device for automatic testing of a first software system, a computer program product and a computer readable medium.

### BACKGROUND OF THE INVENTION

In the field of testing a computer software system using computer software, several methods of testing are known in the art.

A unit test operation comprises three basic steps: A fixture setup step, where the preconditions for the unit test are set up i.e. usually meaning making data for the unit test available and priming a test target for the test; an action step where the action to be tested (e.g. adding a book to a bookstore) is carried out; and a verification step, where the result of the action is verified to match an expectation (e.g. whether the added book can be retrieved using some query).

A data driven test operation is similar to a unit test operation except that the fixture setup step is replaced by a query against a database step that retrieves multiple sets of test data. In the data driven test, the action step and the verification step are executed once for each set of test data retrieved in the query step.

A combinatorial test operation comprising a data driven test where the operation takes multiple parameters:
Operation(param₁, param₂, . . . paramₙ).

In general in the combinatorial test method, there is a query against a database for each parameter param₁ to paramₙ, in which query separate sets of test data P₁ to Pₙ for each parameter are retrieved. The combinatorial test method then produces the Cartesian product P=P₁×P₂× . . . ×Pₙ and executes the method iteratively with parameters set from (param₁, param₂, . . . , paramₙ)=(p₁, p₂, . . . pₙ) ε P for all tuples in P.

A fixed scenario test operation is typically used for concurrency testing and is structured as a sequence of n steps:
1. Setup: Preparation of test data and priming of a test target.
2. Action₁: Performing the first action against the test target.
3. Verification₁: Verification that the first action gave the expected result.
4. . . .
5. Actionₙ: The n^{th} action against the test target
6. Verification: Verification that the n^{th} action gave the expected result

Thus, the fixed scenario test operation is structured as a fixed sequence of actions and accompanying verifications. The setup step can be a fixture setup similar to that from a unit test method; a query like found in the data driven test method or a combinatorial expression like found in the combinatorial test method. A fixed scenario test is commonly used for concurrency testing by executing multiple scenarios simultaneously with different test data in each scenario.

A problem of the unit test method is, for example, that it does not support data management and does not use e.g. entities and/or properties of the entities. Further, the unit test method does not enable organization of e.g. execution order of the tests.

A problem of the data driven test method is, for example, that it assumes the existence of a database comprising fixed test data.

A problem of the combinatorial test method is, for example, that it only enables parameter combinations of data for a plurality of parameters.

A problem of the fixed scenario test method is, for example, that it only executes one or more fixed pre-defined sequences of actions (scenarios).

A further problem of the prior art is the effort required to manage data before and/or during and/or after a test.

An additional problem of the prior art is the retrieving of test data with a direct reference to the test data itself during e.g. combinatorial testing of e.g. a computer software system. Thereby, the prior art does not ensure that (all) relevant combinations of e.g. properties of e.g. entities of the software system have been tested.

Additionally, the prior art uses the same or very similar data in the test. For example, in the unit test method the test data is fixed (in the fixture setup) and in the data driven test method, the test data is constrained to the test data present in the database.

A further additional problem of the prior art is considerable effort required to produce a concurrent test (e.g. tests in which an entity is accessed simultaneously by at least two processes and/or users) and it is difficult and/or impossible to use a non-concurrent test to make a concurrent test due to a limited source of test data.

Therefore, it is an object of the invention to, among other things, solve at least a part of the abovementioned problems.

### SUMMARY OF THE INVENTION

According to the invention, the object is achieved by a method of automatic testing of a first software system using a test specification, the first software system comprising data and interacting with a third software system communicatively coupled to a database; the method comprising defining at least one operation; wherein an operation operates on at least one of at least one entity; defining at least one test condition; wherein a test condition defines at least one required value of a number of properties of at least one entity in order for the at least one entity to be passed on to the at least one operation and wherein said at least one test condition is defined by at least one condition generating expression in said test specification; operating, via said third software system, said at least one operation on said first software system; transmitting from the first software system to the third software system first data representing a result of said at least one operation operating on said first software system; if the first data satisfies at least one criterion used by at least one test condition then storing said first data in said database.

Thereby, the method is able to minimize the requirement for data management because the method itself performs the data management by defining the test conditions using condition generating expressions.

Additionally, the method is able to produce test conditions for all (or substantially all) property combinations of the at least one entity by enabling the definition of test conditions using condition generating expressions.

Further, the invention is able to define test conditions in terms of the at least one entity's at least one property thereby enabling an easy and concise way of ensuring high test coverage at e.g. a functional level.

Further, the invention may use one or more non-concurrent test directly in order to produce a concurrent test. Additionally, the invention enables statistical scenarios which may be expedient for real-life test of the computer software system.

In an embodiment, the defining of at least one operation is performed in a second software system and wherein the operation of said at least one operation by said third software system is performed via said second software system.

In an embodiment, the storing said first data comprises indexing the first data according to at least one entity serving as an input to the at least one operations and/or indexing the first data according to the at least one property of the at least one entity used in the operation.

Thereby is achieved that the stored second data may be retrieved using at least one entity and/or at least one property.

In an embodiment, the at least one entity is categorized into one of: specifiable and consumed and non-consumed; and wherein a specified entity may be instantiated directly from a test condition; wherein a consumed entity is removed from the database after being operated by an operation and wherein a non-consumed entity remains in the database after being operated by an operation.

Thereby is achieved to categorize a number of entities.

In an embodiment, the method further comprises analysing the at least one test condition.

In an embodiment, the analysing comprises assigning a rank of zero to test conditions referring to parameter-less operations and/or operations instantiating specified entities and/or operations operating on non-consumed entities; assigning a value of zero to a current rank parameter; repeating until all test conditions have been ranked: executing of and storing output from observed outcomes of all test conditions with rank equal to the current rank parameter, wherein the storing comprises recording the output in terms of the entities and property values produced by each of the executed test conditions; incrementing the current rank parameter with one; scanning all non-ranked test conditions and assigning a rank equal to the current rank parameter to each non-ranked test condition requiring specifiable parameters and/or consumed parameters output by at least one test condition of rank less than the current rank parameter and/or non-consumed parameters.

In an embodiment, execution of a first test condition comprising a number of parameters is performed by repeating until all parameters of the first test condition have been matched by at least one entity: Searching the database for entities fulfilling a number of input criteria specified by the number of parameters of the first test condition; if entities are found for each of the number of parameters of the first test condition, executing the first test condition and storing a first output of the first test condition in the database; if the first test condition has been executed before and resulted in a second output that differs in the outcome, the types of entities yielded or the properties these entities have, then an error parameter may be set; if a first parameter exists for which an entity is not found, then searching all test conditions with a rank lower than the first test condition for a second test condition producing an entity matching the first parameter; executing the second test condition.

In an embodiment, the searching for a second test condition further comprises: If no second test condition is found, then refraining from executing the first test condition; if one second test condition is found, then executing the second test condition and incrementing a first invocation counter for the second test condition by one; if a plurality of second test conditions are found, then selecting one of the plurality of second test conditions and executing the selected one of the plurality of second test conditions and incrementing a first invocation counter for the selected one of the plurality of second test condition by one.

In an embodiment, selecting the one of the plurality of second test conditions is chosen from the group consisting of: selecting the one of the plurality of second test conditions by a random choice from the plurality of second test conditions; selecting the one of the plurality of second test conditions by a random choice from the plurality of second test conditions sharing the lowest rank; selecting the one of the plurality of second test conditions by a random choice from the plurality of second test conditions having the lowest first invocation counter.

In an embodiment, the selecting the one of the plurality of second test conditions is chosen from the group consisting of: selecting the one of the plurality of second test conditions by a random choice from the plurality of second test conditions; selecting the one of the plurality of second test conditions by a random choice from the plurality of second test conditions sharing the lowest rank; selecting the one of the plurality of second test conditions by a random choice from the plurality of second test conditions having the lowest first invocation counter.

In an embodiment, the executing of all test conditions with rank less than or equal to the current rank parameter is chosen from the group consisting of: Executing test conditions with rank less than or equal to the current rank parameter sequentially; executing test conditions with rank less than or equal to the current rank parameter in a random scenario, wherein the random scenario comprises assigning each test condition a frequency and randomly choosing test conditions for execution according to a frequency distribution of the test conditions.

In an embodiment, the random scenario further comprises if a test condition to be executed has not been assigned a first invocation counter then assigning a second invocation counter to the test condition and incrementing the second invocation counter by one; and if the test condition to be executed has been assigned a first invocation counter, then assigning a second invocation counter to the test condition and incrementing the second invocation counter by one and decrementing the first invocation counter by one and refraining from executing the test condition.

In an embodiment, a plurality of test conditions is executed simultaneously.

Embodiments of the present invention also relates to a device corresponding to embodiments of the method.

As mentioned, the invention also relates to a device for automatic testing of a first software system using a test specification, the first software system comprising data and interacting with a third software system communicatively coupled to a database; the device comprising a first processor for defining at least one operation; wherein an operation operates on at least one of at least one entity; a second processor for defining at least one test condition; wherein a test condition defines at least one required value of a number of properties of at least one entity in order for the at least one entity to be passed on to at least one operation and wherein said at least one test condition is defined by at least one condition generating expression; a third processor for operating said at least one operation on said first software system; a transmitter for transmitting from the first software system to the third software system first data representing a result of said at least one operation operating on said first software system; if the first data satisfies at least one criterion used by at least one test condition then storing said first data in said database.

The device and embodiments thereof correspond to the method and embodiments thereof and have the same advantages for the same reasons.

Embodiments of the present invention also relates to a computer readable medium corresponding to embodiments of the method.

As mentioned, the invention also relates to a computer readable medium having stored thereon instructions for causing one or more processing units to execute the method according to an embodiment of the present invention.

The computer readable medium and embodiments thereof correspond to the method and embodiments thereof and have the same advantages for the same reasons.

### BRIEF DESCRIPTION OF THE DRAWINGS

FIG. 1 shows a computer software system to be automatically tested by an embodiment.

FIG. 2 shows a device for executing an embodiment or a part of an embodiment.

FIG. 3 shows an embodiment of automatically testing a computer software system, wherein the computer software system to be tested comprises an online bookshop.

FIG. 4 shows an embodiment of automatically testing a first computer software system by a second computer software system.

### DETAILED DESCRIPTION OF THE DRAWINGS

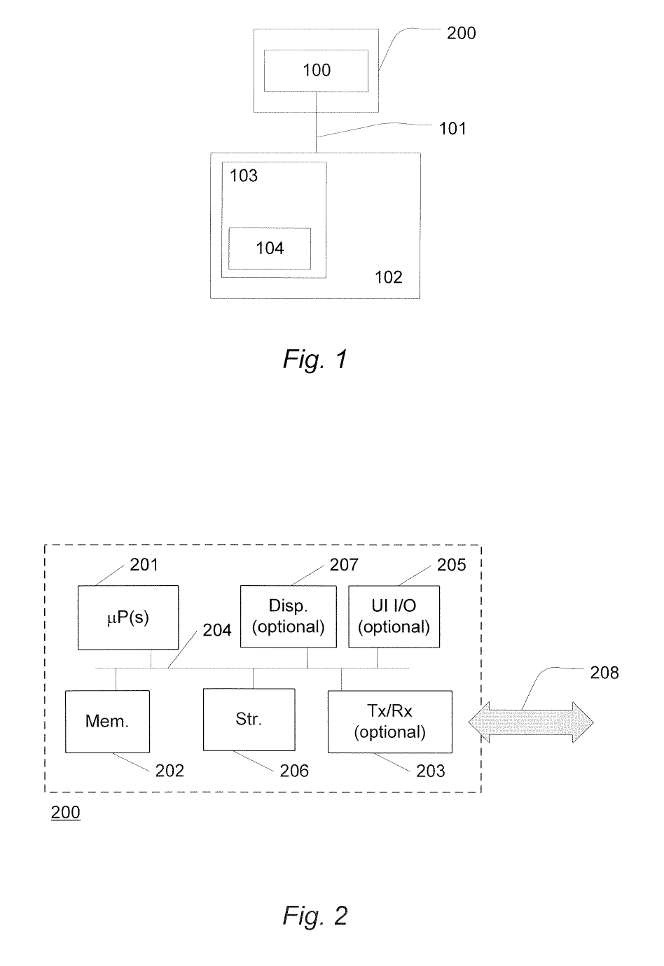

FIG. 1 shows a first computer software system 100. The first computer software system 100 may, for example, be a software application that may be accessed by a second computer system and/or a second computer software system. The first computer software system 100 may, for example, be executed and/or stored on a data processing device 200.

The data processing device 200, shown in FIG. 2, comprises one or more micro-processors 201 connected with a main memory 202 and e.g. a storage device 206 via an internal data/address bus 204 or the like. Additionally, the device 200 may also be connected to or comprise a display 207 and/or communication means 203 for communication with one or more remote systems via one or more wireless and/or wired communication links 208 such as, for example, a Bluetooth communication link, a WLAN communication link, an Infrared communication link, a fiber-optical communication link or the like. The memory 202 and/or storage device 206 are used to store and retrieve the relevant data together with executable computer code for providing the functionality according to the invention. The micro-processor(s) 201 is responsible for generating, handling, processing, calculating, etc. the relevant parameters according to the present invention. The micro-processors 201 may, for example, execute the first computer software system 100. In an embodiment, the micro-processors 201 may execute at least one computer software system such as, for example, a test specification 401 and/or a test application (second computer software system) 419 and/or a first computer software system 402 and/or a third computer software system 410.

The storage device 206 comprises one or more storage devices capable of reading and possibly writing blocks of data, e.g. a DVD, CD, optical disc, PVR, etc. player/recorder and/or a hard disk (IDE, ATA, etc), floppy disk, smart card, PC card, USB storage device, etc.

In an embodiment, the storage device 206 and/or main memory 202 may store at least one computer software system such as, for example, a test specification 401 and/or a test application (second computer software system) 419 and/or a first computer software system 402 and/or a third computer software system 410.

The device 200 may additionally comprise a user interface input/output unit 205 through which a user may interact with the device 200. Examples of user interface input/output units are a computer mouse and a computer keyboard.

The device 200 may thus execute and/or store at least one computer software system such as, for example, a test specification 401 and/or a test application (second computer software system) 419 and/or a first computer software system 402 and/or a third computer software system 410.

The communication means 203 and/or the user input/output unit 205 may provide an interface 101, through which interface 101 the first computer software system 100 may interact with its surroundings 102 such that, for example, data can be inserted and/or queried and/or modified and/or removed from the first computer software system 100 by the surroundings 102.

Alternatively or additionally, a number of actions may be triggered via said interface 101 on said first computer software system 100. An action may, for example be triggered by an entity such as for example a user and/or a second computer software system. A triggered action on the first computer software system 100 may occur immediately when the action is triggered or at some arbitrary later point in time.

Additionally, an action may or may not return a result to the entity triggering it. If a result is returned, the result may, for example, be returned when the action is triggered by an entity and/or when the action occurs on the first computer software system and/or at any arbitrary later point in time. Additionally, triggering one action on the first computer software system 100 may provide zero or more results.

The first computer software system 100 may interact with the surroundings 102 via the interface 101. The interaction may be performed voluntarily and/or spontaneously and/or according to a preset configuration and/or according to one or more external stimuli (e.g. signals and/or commands) from the surroundings 102. The interaction may, for example, be performed by providing the surroundings 102 with data and/or by requesting and/or receiving at least one action from the surroundings 102.

The surroundings 102 may, for example, comprise and/or be connected to a second computer system 103 comprising a second computer software system for automatic testing of the first computer software system 100. The second computer system 103 may, for example, be a device 200 according to FIG. 2. The second computer system 103 may, for example, contain a second computer software system 104 (for example stored in the main memory 202 and/or in the storage device 206 of the second computer system 103), said second computer software system 104 comprising instructions for causing one or more micro-processors 201 of the second computer system 103 to automatically test the first computer software system 100. The test performed by the second computer software system 103 may include a number of test conditions generated by the second computer software system using at least one condition generating expression.

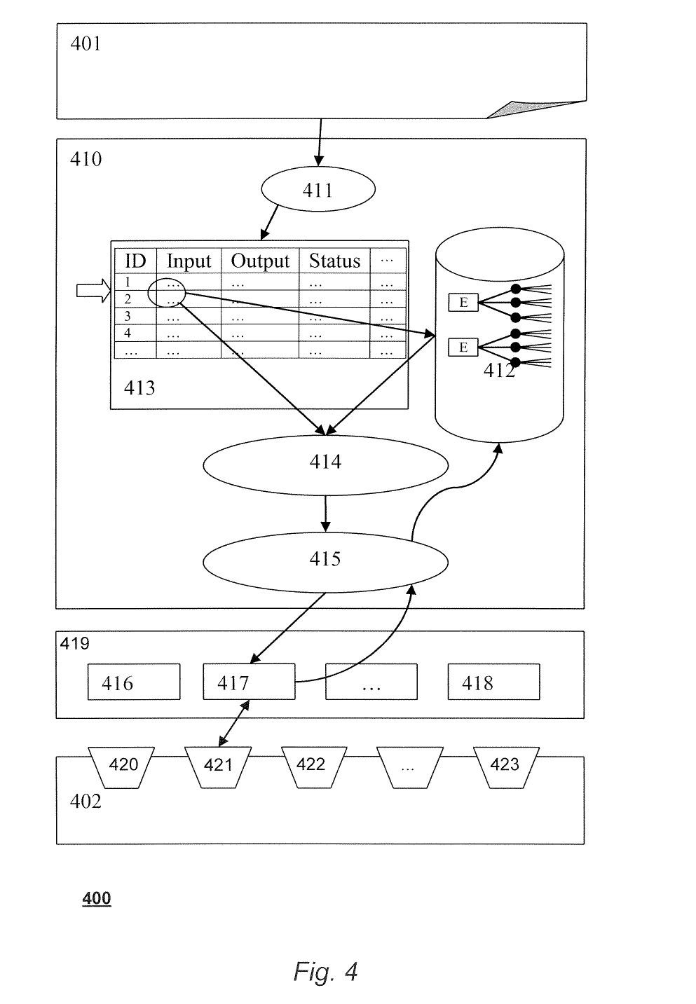

FIG. 4 shows an embodiment of a system 400 for automatic testing of a first computer software system 402 by another computer software system e.g. computer software system 410 and/or 419.

The system 400 may comprise a first computer software system 402 and a third computer software system 410.

The first computer software system 402 may be stored and/or executed on a third data processing device 200 comprising at least one interface 420-423 through which interfaces the first computer software system 402 may interact with, for example, the third computer software system 410. The third computer software system 410 may be stored and/or executed on a fourth data processing device 200. An interface may, for example, contain a wireless and/or a wired communication link 208.

Via the at least one interface 420-423, the third computer software system 410 may, for example, trigger a number of actions, for example one action, on said first computer software system 402. Alternatively or additionally, the third computer software system 410 may monitor the number of actions triggered on said first computer software system 402 via said at least one interface 420-423. Alternatively or additionally, the third computer software system 410 may monitor a number of events triggered by said number of actions triggered by said third computer software system 410 on said first computer software system 402 via said at least one interface 420-423.

The system 400 may further comprise a second computer software system 419 e.g. a test application 419. The second computer software system 419 may be stored and/or executed on a second data processing device. The test application 419 may comprise a number of operations 416-418, for example one operation. An operation 416-418 may, for example, comprise a prescription to do something i.e. to perform at least one action on the first computer software system 402. The at least one action may, for example, be initiated by the third computer software system 410. The test application 419 may be a second computer software product or a component to a computer software.

The test application 419 may, for example, be connected to the first computer software system 402 via an interface 420-423.

An operation (416-418) may take zero or more parameters, each parameter representing an entity with at least one property. An operation may produce zero or more objects, each object representing an entity with at least one property. An operation may either lead to an outcome e.g. an object or a fault, or it may not terminate.

An outcome may, for example, either be a label, for example the label “A” or empty. A fault may have a complex representation but can be uniquely classified into, for example, a label, for example “B”.

An operation 416-418 may not be required to prescribe anything about the properties its input data may have. Further, an operation may not be required to prescribe anything about whether an action initiated by the operation will succeed or fail. Further, an operation may not be required to describe whether a result shall be considered a success or a failure of the test.

In general, an operation is not guaranteed nor expected always to succeed.

A test application 419 may be produced by a person and/or by a computer software product.

Each of the number of operations 416-418 in the test application 419 may be accessible by the third computer software system 410. For example, the second computer software system 419 may be loaded into the third computer software system 410. The third computer software system 410 may, for example, load the test application 419 via an interface 208 and/or via a user input/output unit 205. Alternatively or additionally, the test application 419 may be part of the third computer software system 410.

Additionally, the system 400 may comprise a test specification 401. In order to make a thorough test of a first computer software system 402, all or substantially all (e.g. 85% of all) combinations of properties of data passed to the operations 416-418 should be tested.

The test specification 401 may be stored and/or executed on a first data processing device 200.

The test specification 401 may contain a number of test condition specifications such as for example one test condition specification. A test condition specification may be a mechanism for specifying the conditions under which an operation can be performed and what result to expect from the operation.

A test condition specification may comprise a number of condition generating expressions, for example one, and a number of outcome specifications, for example one, and a number of fault specifications, for example one.

A condition generating expression may be a mechanism, for example a mathematical expression, for generating a number of criteria, for example one, that may be satisfied by the parameters of an operation. A criterion can define at least one property for each parameter of an operation. If the condition generating expression generates a plurality of criteria, each criterion of the plurality of criteria generates at least one test condition.

A test condition may define a criterion for an operation's parameters and may further define an expected outcome.

An outcome specification determines for an outcome:
Whether the outcome is regarded a “success” or a “failure”
Whether multiple invocations of an operation associated with the outcome, invoked with parameters satisfying a first criterion, yield objects that satisfy a second criterion.
Whether the outcome is used for dependency analysis.

A fault specification transforms a number of faults, for example one fault, into an outcome.

A parameter may be characterized as specifiable, if there exists a generator which, given a criterion, can produce an object which satisfies said given criterion.

A parameter may be characterized as consumed if the parameter is removed from a database after being operated by an operation.

A parameter may be characterized as non-consumed if the parameter remains in the database after being operated by an operation.

A rank-0 test condition is a condition where the operation either does not take any parameters at all, or where it is trivial to acquire parameters that satisfy the criterion of the test condition.

A parameter may be trivial to acquire if the parameter is specifiable and/or non-consumable.

Before or as part of executing a number of test conditions, e.g. a set of test conditions comprising three test conditions, the test conditions may be analyzed for dependencies to determine how to fit together a plurality of test conditions such that objects yielded by the execution of one test condition can be used as parameters for other test conditions. The analysis is implemented by the algorithm below which may, for example, be contained in the third computer software system and thus executed and/or stored on the fourth device:

### Algorithm 1-Dependency Analysis

The goal of this algorithm is to record enough information about the set of test conditions regarding what outcome and objects each test condition in the set of test conditions produce and what properties the produced objects have, such that for every test condition in the set of test conditions it becomes possible to produce an arguments required to execute the test condition, or it becomes clear that such arguments cannot reliably be produced.

### Preconditions

a. all test conditions in the set of test conditions are made available in a set such as for example an enumerable list;
b. Identifying all rank-0 test conditions in the set of test conditions;
c. Marking all test conditions as “not executed”, for example by clearing a first flag;
d. Defining a rank comprising a pair of data-structures, a first data-structure comprising a number, e.g. a counter, and a second data-structure comprising a first set of the set of test conditions.

### Algorithm

1. A first rank is constructed comprising a first data-structure assigned to the value zero and a second data-structure assigned all rank-0 test conditions.
2. All test conditions in the current rank are executed by the third computer software system 410 and for every test condition executed using algorithm 2 below, the third computer software system 410 records what the outcome was, and for every object yielded by the test condition it is recorded which criteria that object satisfies. The first flag is set for each executed test condition.
3. An additional rank is constructed comprising a first data-structure assigned to the value of the first data-structure of the first rank incremented by one and a second data structure is assigned a new set of test conditions comprising the test conditions that have not yet been executed (having a cleared first flag) but which can be executed using parameters that are trivial to acquire or parameters available as objects yielded by the execution of test conditions of lower rank.
4. The process is repeated from step 2 as long as the second data structure assigned to the additional rank in step 3 contains a non-empty set of test conditions.

The result of the dependency analysis can be used to guide the execution of the set of test conditions using the following algorithm that determines how a test condition can have data generated for its input parameters before the test condition is executed. The algorithm below may, for example, be contained in the third computer software system and thus executed and/or stored on the fourth device:

### Algorithm 2-Execution of a Test Condition

The goal of this algorithm is to prepare arguments satisfying the criteria of a first test condition to use with the operation of the first test condition. Arguments are either acquired from a database 412 of the fourth device, which database 412 comprises pre-existing objects or objects generated by executing other test conditions, which other test conditions yield objects that can be used as arguments.

### Preconditions

a. A database 412 of objects organized such that the database 412 can be searched by object type and/or by the properties that comprise the parameter criteria of the test conditions in the set of test conditions and/or directly by parameter criteria.
b. The first test condition to be executed, takes n parameters
c. The first test condition to be executed has been analyzed by the third software system 410 and assigned a value r in the first data-structure using the algorithm 1.
d. The first test condition contains two counters c1 and c2.

### Algorithm

1. A parameter count p is set to 0 by the third software system 410.
2. If p=n the algorithm proceeds to execution of the first test condition in step 5 below.
3. If the database 412 contains an object matching the type and criterion for parameter number p in the first test condition then that object is bound to parameter p, and the parameter count p is incremented and the algorithm continues from step 2 above.
4. The test conditions that have been analyzed by the third software system 410 in the dependency analysis and have been assigned a rank less than r in their respective first data-structures are searched for second test conditions yielding an object that matches the type and criteria for parameter number p. The result of this search is denoted result R.
   If the result R is empty, then the first test condition is marked “unable to run” and the algorithm terminates.
   Otherwise, a second test condition in the result R is chosen according to a selection criterion, for example the second test condition may be chosen by random from the result R, and the second test condition is then executed according to this algorithm (algorithm 2) by the third software system 410. Subsequently, the algorithm proceeds from step 2.

### Execution of a Test Condition

5. The first test condition is executed, marked “executed” and the objects yielded by the execution are stored in the database 412.
   a. If a fault is encountered, the number of fault specifications is searched for a specification that can transform the current fault to an outcome. If no specification is found, the first test condition is marked “Failed”, otherwise the first matching fault specification is used to determine the outcome.
   b. If the outcome specification states that the observed outcome is a “failure”, the first test condition is marked failed.
   c. If the outcome specification states that multiple invocations of the first test condition (i.e. the associated operation, with parameters satisfying the criteria stated in the first test condition) must yield objects that satisfy identical criteria, and if there has been a prior execution of the first test condition, then the objects yielded by the current execution are compared to the objects yielded by the previous execution to verify that both sets of objects satisfy the same criteria. If they do not satisfy the same criteria the first test condition is marked “failed”.
   d. If the first test condition is not marked “failed”, the first test condition is marked “success”.
      i. If algorithm 2 has been recursively invoked by algorithm 2 the counter c2 of the first test condition is incremented by 1. Otherwise the counter c1 is incremented by 1. The purpose of c1 is to count the invocations that result from e.g. algorithm 4 step 2. The purpose of c2 is to count the invocations that result from e.g. algorithm 2 step 4. The purpose of algorithm 4 step 3 is to adjust the actually obtained frequency distribution of invocations to approach the probability distribution set in algorithm 4 precondition b.

Execution of test conditions may happen in parallel (i.e. concurrently) by executing one instance of algorithm 2 for each parallel invocation of a test condition.

There are a plurality of methods to select test conditions and schedule them for execution, for example, “Every Condition Once” and “Statistical Scenario”.

### Algorithm 3-Every Test Condition Once

The goal of this algorithm is to execute every test condition at least once. The algorithm below may, for example, be contained in the third computer software system and thus executed and/or stored on the fourth device:

### Preconditions

a. A list of test conditions which have been selected for execution, the list may be enumerable.
b. All selected test condition are marked “not executed”. For example, the third computer program 410 may clear the first flag of each for the selected test conditions.
c. The set of test conditions has been analyzed according to Algorithm 1 by the third computer system 410.

### Algorithm

1. For each test condition in the list of conditions, if the condition is marked “not executed” the condition is executed using algorithm 2.

### Algorithm 4-Statistical Scenario

The goal of this algorithm is to keep executing a plurality of test conditions according to a probability distribution until some stopping criteria is satisfied. When the algorithm terminates, the sum of c1 and c2 for each test condition in the plurality of test conditions is the number of times each respective test condition has been executed.

The algorithm below may, for example, be contained in the third computer software system and thus executed and/or stored on the fourth device:

### Preconditions

a. A list of test conditions which have been selected for execution,
b. Each selected test condition has been assigned a probability between 0 and 1 and the sum of all probabilities sum to 1.
c. All test conditions are assigned two counters, c1 and c2 both initialized to 0.

### Algorithm

1. If the stopping criterion, for example a time limit or an iteration count limit, is satisfied, the algorithm terminates.
2. A first test condition Tc is chosen at random according to the probability distribution.
3. If the counter c2 of the first test condition Tc is greater than 0, c2 is decremented by 1 and c1 of the first test condition Tc is incremented by 1. Otherwise, the first test condition Tc is executed using algorithm 2.
4. The process is repeated from step 1.

The test specification 401 may be a computer software product or a computer software component. A test specification 401 may be produced by a person and/or by a computer software product. The test specification 401 may be stored and/or executed on a device according to FIG. 2, for example a first data processing device 200.

The test specification and/or any number of the number of condition generating expressions contained in the test specification 401 may be loaded by the third computer software system 410 via, for example, an interface 208 and/or via a user input/output unit 205.

In an embodiment, the third computer software system 410 loads the test application 419 or a part of it (e.g. three operations) and the test specification 401 or a part of if (e.g. three condition generating expressions) via an interface 208 and/or via a user input/output unit 205. The test application 419 and the test specification 401 may be stored in the memory 202 and/or storage device 206 of the second computer system 103 executing and storing said third computer software system 410.

During execution, the third computer software system 410 may generate a number of test conditions 413, e.g. two test conditions, based on said test specification 401. The number of test conditions may, for example, be generated by a parser 411 parsing the test specification 401. Each test condition 413 may comprise at least one specification of an operation 416-418 i.e. at least one specification of properties required by at least one input to said operation 416-418 and how the operation 416-418 is expected to respond to the at least one input.

The third computer software system 410 may comprise a database 412 comprising a number of entities, such as for example two entities. An entity may be an item handled by the first computer software system 402, for example, a book, a car, etc.

The database 412 may be indexed by a first index indexing the entities serving as an input to the operations 416-418 and/or by a second index indexing the properties of the one or more entities used in the test specification 401. The database 412 may be contained in the memory 202 and/or the storage device 206 of the fourth data processing device.

When the third computer software system 410 loads the test specification 401, the third computer software system 410 prepares the first and second indexes of the database 412.

In order to test the first computer software system 402, the third computer software system 410 may, for example via plan generator 414, select a first test condition to execute from the number of test conditions 413.

The first test condition may specify a number of properties required to an input to an operation and how the operation 416-418 is expected to respond to the input. The plan generator 414 in the third computer software system 410 may query the database 412 for information on which entities in the database fulfill the specified properties of the required input. The plan generator 414 may, for example, quire the database via the first and/or the second indexes.

If a required first input to an operation may not be found in the database, the plan generator 414 may search the number of test conditions for a second test condition, which second test condition may produce said required first input.

If no second test condition is found in the database, the first test condition may be marked with a flag, said flag indicating that the first test condition is unable to be executed.

Otherwise, if a second test condition is found, the third computer software system 410 may query the database 412 for information on which entities in the database fulfill the specified properties of the required input to the second test condition. If a required first input to an operation may not be found in the database, the plan generator 414 of the third computer software system 410 may search the number of test conditions for a third test condition, which third test condition may produce said required first input etc.

When all required input is found, the plan generator 414 may invoke an operation 416-418 associated with the first test condition via an invoker 415 of the third computer software system 410.

During invocation of the operation 416-418 by the invoker 415, the operations may generate and monitor a number of actions on the first computer software system 402, for example two actions. All data transmitted from and received by the by the operation are collected by the invoker 415 and stored in the database 412.

In an embodiment, the test specification 401 may be stored and/or executed on a first data processing device 200 as shown in FIG. 2 and the test application (second computer software system) 419 may be stored and/or executed on a second data processing device 200 as shown in FIG. 2. In this embodiment, the first and third computer software systems 402 and 410 may be stored and/or executed on third and fourth data processing devices 200 as shown in FIG. 2, respectively.

In an embodiment, the test specification 401 may be contained in the test application (second computer software system) 419, which test application may be stored and/or executed on a second data processing device 200 as shown in FIG. 2. In this embodiment, the first and third computer software systems 402 and 410 may be stored and/or executed on third and fourth data processing devices 200 as shown in FIG. 2, respectively.

In an embodiment, a first part of the test specification 401 may be stored and/or executed on a first data processing device 200 as shown in FIG. 2 and a second part of the test specification 401 may be contained in the test application (second computer software system) 419, which test application may be stored and/or executed on a second data processing device 200 as shown in FIG. 2.

The test specification 401 may, for example, comprise a plurality of test condition specifications, such as four test condition specifications. The first part of the test specification 401 may, for example, comprise at least one test condition specification, such as one test condition specification. The second part of the test specification 401 may, for example, comprise at least one test condition specification, such as three test condition specifications.

In this embodiment, the first and third computer software systems 402 and 410 may be stored and/or executed on third and fourth data processing devices 200 as shown in FIG. 2, respectively.

In an embodiment, the test specification 401 may be stored and/or executed on a first data processing device 200 as shown in FIG. 2. The test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, the test specification 401 may be contained in the test application (second computer software system) 419 and additionally, the test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419, and additionally, the test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, the test specification 401 may be stored and/or executed on a first data processing device 200 as shown in FIG. 2. The test application (second computer software system) 419 may be contained in the first computer software system 402, which first computer software system 402 may be contained in the third computer software system 410, which third computer software system 410 may be stored and/or executed on a fourth data processing device 200 as shown in FIG. 2.

In an embodiment, the test specification 401 may be contained in the test application (second computer software system) 419. The test application 419 may be contained in the first computer software system 402. The first computer software system 402 may be contained in the third computer software system 410, which third computer software system 410 may be stored and/or executed on a fourth data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419. The test application 419 may be contained in the first computer software system 402. The first computer software system 402 may be contained in the third computer software system 410, which third computer software system 410 may be stored and/or executed on a fourth data processing device 200 as shown in FIG. 2.

In an embodiment, the test specification 401 may be stored and/or executed on a first data processing device 200 as shown in FIG. 2. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

In an embodiment, the test specification 401 may be contained in the test application (second computer software system) 419. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

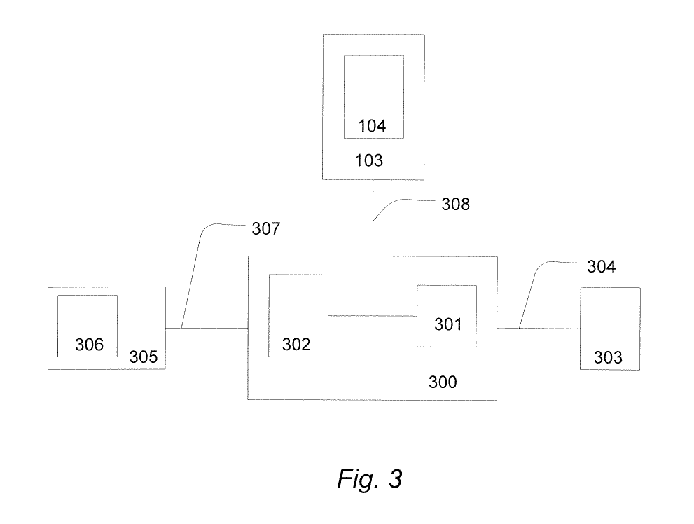

FIG. 3 shows an embodiment in which the computer software system to be tested is an online bookshop 300.

In FIG. 3, an embodiment is shown in which the first computer software system 100 contains an online bookshop 300 which is to be automatically tested by a second computer software system 104. The online bookshop 300 may, for example, be hosted on a device 200 according to FIG. 2.

The online bookshop 300 may, for example, comprise:
A book 301 which can be added to the online bookshop 300. For example, an added book 301 may be displayed on a homepage 302 of the online bookshop 300. Thereby, the added book 301 can be purchased in the online bookshop 300, for example by a customer device 303 visiting the online bookshop 300 via the homepage 302. The customer device 303 may, for example be a device 200 according to FIG. 2. The customer device 303 may, for example, be connected to the online bookshop 300 e.g. via a network 304 such as the Internet and/or any other type of network such as LAN, WAN, Bluetooth, etc. enabling the customer device 303 to interact with the online bookshop 300.
A stock 305 comprising a number of books. For example, the stock 305 may comprise a number of added books and/or a number of books not added to the online bookstore 300. The stock 305 may, for example, comprise a stock computer 306. The stock computer 306 may, for example, be a device 200 according to FIG. 2. The stock computer 306 may interface with the online bookshop e.g. via a network 307 such as, for example, the Internet and/or a LAN and/or a WAN, etc. The interfacing between the online bookshop 300 and the stock computer 306 may, for example, provide the homepage 302 with information regarding which books are on stock and which books that are not on stock. The stock 305 can be replenished so there will be books for a customer device 303 to receive e.g. after a purchase from the online bookshop 300. In an embodiment, books to be replenished require to be on a list in the online bookshop.
A book 301 may comprise a price, and the price of a book can be changed. Further, a book 301 may comprise an ISBN number and/or an author and/or a title and/or a category.
A customer can via a customer device 303 search a number of books in the online bookshop 300, for example, a customer may search all books in the online bookshop 300 e.g. via the homepage 302. The search may, for example, be performed using ISBN and/or author and/or title and/or category. All books 301 in the online bookshop may comprise an ISBN. However, a number of books 301 may not have e.g. an author (e.g. the Bible). Further, a number of books 301 may not comprise a title (e.g. a book not yet available).
A customer accessing the online bookshop homepage 302 e.g. via the customer device 303 may be associated with an electronic shopping cart on the homepage 302. The customer may add any number of books to the electronic shopping cart (e.g. any positive number or zero copies of any number of books 301 which have been added to the online bookstore 300).
If a customer decides to pay e.g. via the customer device 303, a number of books may be unavailable in the stock 305. In that case the customer may be given a choice to pay up front and receive the number of books not in stock when they become available or to reserve the number of books not in stock without paying and receiving a notification via email when the books not in stock become available. A notification may, for example, require a response from the customer by e.g. an order confirmation from the customer. The customer response may, for example, be required within a set time interval, otherwise the reservation may be cancelled.

To automatically test the online bookshop 300, a second computer software system such as a test software product 104 for automatic testing may be utilized. The test software product may be contained in a second computer system 103 and may, for example, be connected to the online bookshop 300 (for example to the homepage 302). The second computer system 103 may be connected to the online bookstore 300 for example via a network 308 such as for example the Internet and/or any other type of network such as LAN, WAN, Bluetooth, etc.

The test software product 104 may, for example, require knowledge of a number of entities of the online bookshop 300. For example, the test software product 104 may require knowledge of all entities in the online bookshop 300.

An entity of the online bookshop may, for example, be a book 301 and/or a price of a book and/or the stock 305 and/or an electronic shopping cart and/or a reservation of a book by a customer and/or a notification to a customer regarding availability of a reserved book etc.

Each entity may comprise a number of properties. A property of a book 301 may, for example, be whether the book has an ISBN number or not. Alternatively or additionally, a property of a book 301 may be whether or not the book has a price and/or an author a price and/or a title and/or a category. A further property of a book 301 may, for example, be whether the book 301 is in the stock 305. Alternatively or additionally, a property of a book 301 may be whether the book 301 is enlisted on the homepage 302 of the online bookshop 300.

Similarly one or more of the other entities (e.g. the price of a book and/or the stock 305 and/or the electronic shopping cart and/or the reservation of a book by a customer and/or the notification to a customer regarding availability of a reserved book) of the online bookshop 301 may comprise a number of properties.

The test software product 104 may comprise a number of operations. An operation may, for example, consume one or more entities of the online bookshop 300. Alternatively or additionally, an operation may produce one or more entities on the online bookshop 300 e.g. as a result of the operation.

For example, the test software product 104 may comprise an operation of adding a book 301 to the online bookshop 300. Thereby, the operation may consume one book 301 and attempt to add the book 301 to the online bookshop 300. If the operation is successful, the book 301 may subsequently be marked as “in the online bookstore” wherein the mark, for example, may be a property of the book 301. Subsequently, the book 301 may be returned to the test software product 104 for example in order to be re-indexed according to its changed properties (i.e. that the book 301 is now available in the online bookstore 300).

In general, an operation is not guaranteed nor expected always to succeed: If, for example, a valid book, i.e. a book 301 comprising an ISBN number and which is not marked as being added to the homepage 302, is subjected to the abovementioned operation of adding a book to the homepage, then the operation may be expected to succeed. A failure to succeed may be considered as a test error i.e. as an error of the computer program system 100 e.g. an error in the online bookstore 300.

If, for example, a book without ISBN and/or a book being marked as being added to the online bookstore 300 is attempted added to the online bookstore 300, the operation of adding a book to the online bookstore may be expected to fail. If the operation of adding a book to the online bookstore 300 does not fail in such an example, then it may be considered as a test error i.e. as an error of the computer program system 100 e.g. an error in the online bookstore 300.

In general, an operation may be a prescription to do something i.e. to perform at least one action on the computer software system 100 by the test software product 104 and/or the means 103 for automatic testing.

An operation may not be required to prescribe anything about the properties its input data may have. Further, an operation may not be required to prescribe anything about whether an action will succeed or fail. Further, an operation may not be required to describe whether a result shall be considered a success or a failure of the test.

The test software product 104 may further comprise a number of test conditions. A test condition may comprise a specification of what properties data to be passed to an operation may be required to have. Additionally, a test condition may determine how an operation may be expected to react with the data (e.g. success or failure).

For example, an operation testing whether a book can be added to the online bookstore 300 may be comprised in a test condition stating that:
The book may not already be on the homepage 302;
the book may have an ISBN number; and
the operation may be expected to succeed in adding the book.

A complete list of test conditions may be contained in a test specification.

The test software product 104 may further comprise a number of condition generating expressions. A condition generating expression may be a mechanism for providing a number of test conditions.

Additionally or alternatively, a condition generating expression may comprise a set of expressions in at least one property of at least one input parameter (e.g. an entity) to an operation. A number of conditions (e.g. all conditions) generated by a condition generating expression may be expected to lead to the same result e.g. a success and/or a failure and/or a specific failure of more than one type of failure of the operation.

For example, in order to make a thorough test of adding a book 301 to the online bookstore 300, the test software product 104 may test all relevant combinations of book properties, such as, for example, the combinations of whether the book has a title and/or an author and/or a category.

In general, a condition generating expression may be a concise way of specifying a number of test conditions (e.g. at least two test conditions).

Thus, in an embodiment, the test software product 104 may comprise and/or utilize and/or involve one or more of the following:
Entities—Items handled by the computer program system 100 being tested by the test software product such as for example books and/or prices and/or shopping carts etc.
Properties—of the entities such as, for example, a Boolean variable indicating whether e.g. a book 301 has an author and/or whether a book 301 has a title and/or whether a book 301 is presented on the homepage 302 of the online bookshop 300, etc.
Operations—which may perform a number of actions on the computer program system 100 being tested, such as for example adding a book to the homepage 302, replenishing the stock 305, querying a customer whether the customer would like to pay in advance or reserve a book, responding to a notification from a customer, etc.
   An operation may, for example:
      1. Accept zero or more entities as input.
      2. Perform at least one action on the computer program system 100 under test using the entities.
      3. Verify the result of the at least one action performed on computer program system 100 under test.
      4. Return a number of entities input into the operation to the test software product 104.
Condition generating expressions—specifying a number of test conditions under which the operations may be invoked during the test of the computer program system 100.

In general, the test software product 104 may be responsible for managing a number of entities and executing a number of test conditions and managing the execution order of a number of test conditions and managing the number of times each test condition is executed such that data becomes available to execute all possible conditions in the test.

A test author, e.g. a person supervising the test software product 104, or a software product may define a number of operations and/or defining the condition generating expressions.

In an embodiment, Backus-Naur-Form (BNF) may be utilized as syntax in order to specify a number of test conditions e.g. a list of test conditions i.e. BNF may be used as a condition generating expression.

For example, a list of test conditions may be generated using a BNF specified condition generating expression:

$$EXPR :: = EXPR OP EXPR \vert ( EXPR ) \vert TUPLE \vert SET \vert parameter\_name . EXPR\_PA \vert parameter\_name . property\_name . EXPR\_PR$$

$$EXPR\_PA :: = EXPR\_PA op EXPR\_PA \vert ( EXPR\_PA ) \vert TUPLE\_PA \vert SET\_PA \vert property\_name . EXPR\_PR$$

$$EXPR\_PR :: = EXPR\_PR op EXPR\_PR \vert ( EXPR\_PR ) \vert TUPLE\_PR \vert SET\_PR$$

$$OP :: = + \vert - {\vert}^{*} \\ SET :: = \{ TUPLE\_comma \_separated \_list \} \vert \{ VALUE\_comma \_separated \_list \} \vert \{ ! VALUE \} \vert \{ * \}$$

$$SET\_PA :: = \{ TUPLE\_PA \_comma \_separated \_list \} \vert \{ VALUE\_PA \_comma \_separated \_list \} \vert \{ ! VALUE\_PA \} \vert \{ * \}$$

$$SET\_PR :: = \{ TUPLE\_PR \_comma \_separated \_list \} \vert \{ VALUE\_PR \_comma \_separated \_list \} \vert \{ ! VALUE\_PR \} \vert \{ * \}$$

$$TUPLE :: = [ VALUE\_comma \_separated \_list ]$$

$$TUPLE\_PA :: = [ VALUE\_PA \_comma - separated\_list ]$$

$$TUPLE\_PR :: = [ VALUE\_PR \_comma - separated\_list ]$$

$$VALUE :: = parameter\_name . property\_name . value\_name$$

$$VALUE\_PA :: = property\_name . value\_name$$

$$VALUE\_PR :: = value\_name$$

The terminals in this syntax are value_name, property_name, parameter_name.

parameter_name may be a name representing a parameter of an operation.

property_name may be a name representing a property of the parameter identified by the closest preceding parameter_name.

value_name may be a name representing a value of the property identified by the closest preceding property_name.

The use of the suffix “_comma_separated_list” after a non-terminal means that the non-terminal can be repeated zero or more times with a comma (“,”) separating each repetition.

Alternatively, any syntax or meta-syntax may be used to specify a number of condition generating expressions. An example of an alternative meta-syntax is Extended BNF.

In general, any of the technical features and/or embodiments described above and/or below may be combined into one embodiment. Alternatively or additionally any of the technical features and/or embodiments described above and/or below may be in separate embodiments. Alternatively or additionally any of the technical features and/or embodiments described above and/or below may be combined with any number of other technical features and/or embodiments described above and/or below to yield any number of embodiments.

Although some embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1-15. (canceled)

16. A method of automatic testing of at least one system under test (SUT 523, 631, 740) accessed through at least one interface method (IM 522, 622, 731) defined in a code under test (CUT 520, 620, 730) which is accessed via at least one test method (TM 512, 612, 721, 801, 930) defined in a test driver code (TDC 510, 610, 720) which is accessed via a test runner (TR 710, 910); wherein the test runner (TR 710, 910) comprises a list of test conditions (TC list 719), a dependency analysis algorithm (711) and an algorithm for preparing and executing a single test condition (712), wherein the method comprises:
defining in the test driver code (TDC 510, 610, 720) at least one data type (MMC 511) defining at least one classification of the data type onto a first finite set of classes (MMCC);
defining in the test driver code (TDC 510, 610, 720) at least one test method (TM 512, 612, 721, 801, 930), wherein at least one of the at least one test method (TM 512, 612, 721, 801, 930) requires at least one parameter of the data type (MMC 511), and wherein each of the test methods (TM 512, 612, 721, 801, 930) produces an outcome (TMIO 912), which can be classified onto a second finite set of classes (TMEO 913), and wherein at least one test method (TM 512, 612, 721, 801, 930) produces at least one output (TMCO 940) of the data type (MMC 511);
defining in the test runner (TR 710, 910) a list of test conditions (TC list 719), wherein each test condition (TC 800) identifies one test method (TM 512, 612, 721, 801, 930), and for each parameter in the test method (TM 512, 612, 721, 801, 930), the test condition (TC 800) specifies one equivalence class (MMEC, 8020), and wherein each test condition (TC 800) defines the classification (803) of the test method's outcome (TMIO 912) onto the second finite set of classes (TMEO 913) containing at least a success value (OK) and a fail value (FAIL);
executing in the test runner (TR 710, 910) a test method (TM 512, 612, 721, 801, 930) according to a test condition (TC 800), wherein each parameter value in the test method (TM 512, 612, 721, 801, 930) belongs to the equivalence class (MMEC, 8020) specified for the parameter in the test condition (TC 800);
during execution of the test method (TM 512, 612, 721, 801, 930), the test runner (TR 710, 910) records the at least one output (TMCO 940) from the test method (TM 512, 612, 721, 801, 930);
after execution of the test method (TM 512, 612, 721, 801, 930), the test runner (TR 710, 910) records the test method's outcome (TMIO 912) and performs the classification (803) of the test method's outcome (TMIO 912) onto the second finite set of classes (TMEO 913) specified in the test condition (TC 800) to produce a value (TMEOV) contained in the second finite set of classes (TMEO 913);
if the value (TMEOV) does not indicate a failure (FAIL), then determining an equivalence class to which the at least one output (TMCO 940) recorded by the test runner (TR 710, 910) belongs and indexing the at least one output in a first database (TRDB_MMO 716, 915) of the test runner (TR 710, 910) according to the at least one equivalence class to which the output belongs;
if the value (TMEOV) indicates a success (OK), then determining an equivalence class to which the at least one output (TMCO 940) recorded by the test runner (TR 710, 910) belongs and recording the equivalence class (MMEC) in an observed output (804) of the test condition.

17. A method according to claim 16, wherein the code under test (CUT 520, 620, 730) comprises at least one component, wherein a component is either contained in the system under test (SUT 523, 631, 740) or identical to the system under test (SUT 523, 631, 740) or disjoint from the system under test (SUT 523, 631, 740).

18. A method according to claim 17, wherein the test driver code (TDC 510, 610, 720) comprises at least one component, wherein a component is either contained in the code under test (CUT 520, 620, 730) or identical to the code under test (CUT 520, 620, 730) or disjoint from the code under test (CUT 520, 620, 730).

19. A method according to claim 18, wherein at least one test method (TM 512, 612, 721, 801, 930) produces at least one second output (TMUO 950) of the data type (MMC 511).

20. A method according to claim 19 wherein if TMEO (913) is equal to OK then for each meta-model-object (MMO) in the second output (TMUO 950), the meta-model-object MMO is added to the first database (TRDB_MMO 716, 915).

21. A method according to claim 18, wherein the data type (MMC 511) comprises at least one of:
1. an identifier (MMC-Identifiable) providing unique identification of different instances of the data type; and
2. a method (MMC-Settable) of instantiating the data type such that it belongs to an equivalence class (MMEC) applicable to that data type; and
3. a marker (MMC-Singleton) applying to any instance of that data type.

22. A method according to claim 21, wherein a test condition (TC 800) is identified as enabled if it does not take any parameters or if for each meta-model-equivalence-class (MMEC) in an input specification (802) of the test condition (TC 800) it is true that either the meta-model-class (MMC) associated with the meta-model-equivalence-class (MMEC) is identified as MMC-Settable or the meta-model-equivalence-class is indexed in a second database (TRDB_TC 715).

23. A method according to claim 22, wherein the executing of a first test condition (TC 800) comprises a second algorithm comprising:
1. If the first test condition has a rank of value less than 0 then terminating the method;
2. If the second database (TRDB_TC 715) has not been initialized up to a rank value at least one lower than the rank of the first test condition and the first test condition does not have a rank of zero, then terminating the method;
3. If first test condition is not enabled, then terminating the method;
4. Initializing an “ARGS” variable (911) capable of containing a list of meta-model-objects to an empty list;
5. Initializing a “MMEC_UNBOUND” variable capable of containing zero or one meta-model-equivalence-class to contain zero meta-model-equivalence-class,
6. L0: For each meta-model-equivalence-class (MMEC) in the input specification (802) of the first test condition (TC 800) for which there has not been acquired a meta-model-object belonging to the meta-model-equivalence-class (MMEC), the first database (TRDB_MMO 716, 915) is searched for a meta-model-object belonging to the meta-model-equivalence-class (MMEC); storing the zero or one resulting meta-model-objects in a “MMO2” variable; if the MMO2 variable is not empty then performing step 6a, else performing step 6b;
Step 6a;
1. removing the MMO2 variable from the first database (TRDB_MMO 716, 915);
2. adding the MMO2 variable to the ARGS variable (911);
Step 6b;
1. adding to the first database (TRDB_MMO 716, 915) all meta-model-objects in the ARGS variable (911);
2. clearing the ARGS variable (911),
3. adding the current meta-model-equivalence-class to the MMEC_UNBOUND variable;
4. proceeding to step [L1];
7. L1: If MMEC_UNBOUND does not contain a MMEC then proceeding to step [L2], else the second database (TRDB_TC 715) is searched for the test condition of a rank lower than the rank (806) of the first test condition that is keyed by the value of MMEC_UNBOUND resulting in a second test condition (TC2);
8. recursively executing the second test condition TC2 in the second algorithm wherein the second test condition takes the place of the first test condition (TC 800);
9. proceeding to step [L0];
10. L2: executing the test method (TM 512, 612, 721, 801, 930) of the first test condition using the meta-model-objects in the ARGS variable (911) as arguments and collecting test method immediate output (912) and test method checked output (940) values;
11. classifying the test method's outcome (TMIO 912) into TMEO (913) using the outcome mapping (803) of the first test condition (800).
12. if TMEO (913) is equal to OK then proceeding to step [L3] else if TMEO (913) is equal to FAIL, then proceeding to step [L4];
13. L3: creating a new set of meta-model-equivalence-classes (MMECs) and storing the new set of meta-model-equivalence-classes MMECs in a new variable OBS; For each meta-model-object (MMO) in the output (TMCO 940), the meta-model-equivalence-class MMEC of the meta-model-object MMO is found and added to the new variable OBS; assigning the new variable OBS to the observed output (804) of the first test condition (800); storing all meta-model-objects (MMO) in the first database (TRDB_MMO 716, 915); continuing from [L5];
14. L4: clearing output (TMCO 940) and signaling the test runner (TR 710, 910) that the execution of the first test condition has failed; and terminating the method;
15. L5: If the algorithm has been recursively called from itself then incrementing by one InvocationCount2 (809) of the first test condition (TC 800), else incrementing by one InvocationCount1 (808) of the first test condition (TC 800).

24. A method according to claim 23, wherein the method further comprises:
1. Initializing a “current rank” variable to the value 0;
2. Storing all test conditions (TC 800) in an enumerable list “UL” containing unranked test conditions and wherein each test condition (TC 800) having its rank (806) reset to a default value;
3. Initializing a “CL” variable capable of containing test conditions (TC 800);
4. Clearing the second database (TRDB_TC 715);
5. Repeating until the method terminates:
a. Clearing the CL variable;
b. deleting test conditions identified as enabled from the enumerable list (UL) and adding them to the “CL” variable;
c. If the CL variable is empty then marking all test conditions in the UL list as unable to run and terminating the method;
d. assigning the value of the current rank variable to the rank (806) of each test condition (800) in the CL variable;
e. If the UL list is empty then terminating the method;
f. executing any test condition in the CL list which has not had its observed output (804) set;
g. adding all test conditions in the CL list to the second database (TRDB_TC 715), indexing each test condition (TC 800) by the rank of the test condition (806) and by each meta-model-equivalence-class (MMEC) in the observed output (804);
h. incrementing the “current rank” variable by one.

25. A method according to claim 23, wherein the method further comprises:
1. If a test condition (TC 800) has a rank value (806) of default value then terminating the method;
2. For each test condition (TC 800) initializing the value of InvocationCount1 (808) of the test condition (800) to 0, and initializing the value of InvocationCount2 (809) of the test condition (800) to 0;
3. For each test condition (TC 800); if the sum of InvocationCount1 (808) and InvocationCount2 (809) is 0 then executing the test condition (TC 800).

26. A method according to claim 23, wherein the method comprises:
1. If a test condition (TC 800) has a rank value (806) of default value then terminating the method;
2. If a test condition (TC 800) has a target probability value (806) greater than 1 or less than 0 then terminating the method;
3. If the sum of the target probability value (806) of all test conditions (800) is not 1 then terminating the method;
4. L1: For each test condition (800) initializing the value of InvocationCount1 (808) to 0; and initializing the value of InvocationCount2 (809) to 0.
5. Terminating the method if a stopping criterion is satisfied, the stopping criterion comprising one of;
a. a time limit, or
b. an iteration count limit;
6. A first test condition (TC 800) is chosen at random according to the probability distribution;
7. If InvocationCount2 (809) of the first test condition is greater than 0, then decrementing by 1 InvocationCount2 (809) and incrementing by 1 InvocationCount1 (808),
else executing the first test condition;
8. The method proceeds from [L1];

27. A method according to claim 23, wherein the output (TMCO 940) and/or the second output (TMUO 950) contains a timestamp indicating a point in time from which the output and/or the second output is valid for use as a parameter value for a test method.

28. A method according to claim 27, wherein the output (TMCO 940) and/or the second output (TMUO 950) contains a timestamp indicating a point in time from which the output and/or the second output is valid for use as a parameter value for a test method and wherein the method further comprises; If the “ARGS” variable (911) contains at least one timestamp then delaying the execution of the test method (TM 512, 612, 721, 801, 930) of the first test condition (800) until the time has passed all of the at least one timestamps.

29. A method according to claim 21, wherein the method further comprises organizing a number of identifiers in a managed object graph (MOG) stored in a third database (TRDB_MOG 717, 916), wherein the managed object graph comprises a collection of vertices and directed edges, and wherein a vertex is an identifier and a directed edge is an ordered pair of vertices.

30. A method according to claim 29, wherein a new directed edge is recorded as a third output (TMNCON 960), when the test method (TM 512, 612, 721, 801, 930) is executed and wherein a deletion of a directed edge is recorded as a fourth output (TMDCON 970), when the test method (TM 512, 612, 721, 801, 930) is executed.

31. A method according to claim 23, wherein the method further comprises organizing a number of identifiers in a managed object graph (MOG) stored in a third database (TRDB_MOG 717, 916), wherein the managed object graph comprises a collection of vertices and directed edges, and wherein a vertex is an identifier and a directed edge is an ordered pair of vertices and wherein a new directed edge is recorded as a third output (TMNCON 960), when the test method (TM 512, 612, 721, 801, 930) is executed and wherein a deletion of a directed edge is recorded as a fourth output (TMDCON 970), when the test method (TM 512, 612, 721, 801, 930) is executed; and wherein prior to the execution of the test method, a transitive closure (TCLOS 914) has been computed from the third database (TRDB_MOG 717, 916) using the identifiers of the parameter values as roots for the computation; removing from the first database (TRDB_MMO 716, 915) the meta-model-objects (MMO) identified by the vertices in the transitive closure (TCLOS 914); after the execution of the test method (TM 512, 612, 721, 801, 930) and if the value (TMEOV) indicates a success (OK), then each third output (TMNCON 960) is added to the third database (TRDB_MOG 717, 916), and each fourth output (TMDCON 970) is removed from the third database (TRDB_MOG 717, 916), and if the transitive closure (TCLOS 914) is not empty, each data type instance (MMO) identified in the transitive closure (TCLOS 914) and reachable from any meta-model object (MMO) in the first database (TRDB_MMO 716, 915) through the third database (TRDB_MOG 717, 916) is added to the first database (TRDB_MMO 716, 915).

32. A method according to claim 23 wherein a plurality of test conditions (TC 800) is executed simultaneously.

33. A device for automatic testing of at least one system under test (SUT 523, 631, 740), wherein the device is adapted to execute the method according to claim 18.

34. A computer readable medium having stored thereon instructions for causing one or more processing units (201) to execute the method according to claim 18.

35. A computer program product comprising program code means adapted to perform the method according to claim 18, when said program code means are executed on one or more processing units (201).
